(19) United States
(12) Patent Application Publication
(10) Pub. No.: US 2019/0034547 A1
(43) Pub. Date: Jan. 31, 2019

(54) INTERNET PORTAL SYSTEM AND METHOD OF USE THEREFOR

(71) Applicant: Gum Cheol KIM, Incheon (KR)

(72) Inventor: Geum Cheol KIM, Incheon (KR)

(21) Appl. No.: 16/072,188

(22) PCT Filed: Jan. 26, 2016
(86) PCT No.: PCT/KR2016/000831

§ 371 Date: Jul. 24, 2018

(51) Int. Cl. G06F 17/30; H04L 29/06; H04L 29/08

(52) U.S. Cl. CPC G06F 17/30887; H04L 63/0281; H04L 67/2814; H04L 63/08

(57) ABSTRACT

An Internet portal system and a method of use therefor, according to the present invention, provide a safe and convenient private Internet portal system to an individual by using, as core elements, a server for managing the private Internet portal site and a URL medium, which is assigned to each individual, can access a private Internet portal site, and stores a URL having authentication information configured therein. The present invention is safe since the URL medium must be used so as to prevent the access of an anonymous user when accessing a private Internet portal server, is convenient since an immediate access is performed by using the URL medium, is safe since the URL medium-authentication information configured in the URL medium is confirmed after the access so as to perform a login in the URL medium unit, and provides the structural safety because of access to a secondary site through a portal by which personal identity is verified. In addition, the private Internet portal site establishes a special relationship with another site (=secondary site) through a proxy, who is present on the Internet on behalf of an individual, thereby supporting a payment service for efficiently preventing an illegal payment by using the same.

### CROSS-REFERENCE TO RELATED APPLICATIONS

This patent application is a national-stage application of International Patent Application No. PCT/KR2016/000831, filed on Jan. 26, 2016, the disclosure of which is incorporated by reference herein in its entirety.

### TECHNICAL FIELD

The present invention relates to an Internet portal system and a method for using the same, and more specifically, to an Internet portal system that may provide better security and convenience and interactions with secondary sites to support payment and a method for using the same.

### DISCUSSION OF RELATED ART

Conventional Internet portals, by their nature of being able to be accessed by anyone, cannot be put to use only for some individuals or cannot be provided in a customized manner and are unavailable for one-step access. Methods in which such an Internet portal and a secondary site distinguish between a user and the others involve using authentication information that the user memorizes but cannot apply a structure of interworking with a different attribute of authentication information as does the present invention that uses a medium storing a URL assigned to an individual, containing various pieces of information, and has authentication information set therein and distinguishes between users by associating authentication information memorized by the user with information about the Internet portal accessing a secondary site.

Further, conventional Internet portals only play a role to connect to secondary sites, failing to provide any service to support payment in interoperation with a secondary site.

### SUMMARY

There are provided an Internet portal system, which is customized for personal purposes, is safely used in a multi-login structure with a different attribute of authentication information, is accessible with a simple operation, and enables use of various services while interworking with a secondary site and a method for using the same.

There are provided an Internet portal system supporting payment and a method for using the same.

The foregoing objectives of the present invention are achieved by an Internet portal system, which includes a URL medium 100, 100a, or 100b storing and providing a URL containing information associated with a secondary site 400a and enabling access to an individual-dedicated private portal site 300a and retaining URL medium-authentication information set in the URL, a smart device 200 accessing the private portal site and the secondary site using the URL, a private portal server 300 managing the private portal site, and a secondary site server 400 managing the secondary site and a method for using the same.

Further, the above objects are achieved by an Internet portal system including a URL medium 100a or 100b storing and providing a URL containing information associated with a secondary site (i.e., the card company site 400a) and enabling access to an individual-dedicated private portal site 300a and retaining URL medium-authentication information set in the URL, a smart device 200 accessing a private portal site 300a and a secondary site using the URL, a private portal server 300 managing the private portal site, a secondary site server 400 managing the secondary site, a secondary site interworking server (i.e., the card company payment server) 600 managing payment of the URL medium 100a or the payment medium 900, a payment terminal 700 performing payment, and the URL medium 100a or payment medium requesting the payment terminal to perform payment and a method for using the same.

An Internet portal may be available in an individual-dedicated, customized manner. A person's real life and Internet life information may be associated together. The activities on the Internet may be managed and used systematically and effectively. Ones may be relieved of the stress that they need to memorize for Internet activities. Once connected to an Internet server, the person's major sites or sites of interest are rendered available all the time regardless of places or despite changing terminals.

The person's actual life information is not provided. After the person's identity is verified in multiple ways, access to the secondary site containing the person's life information can be made, thus leading to a high commercial value and a reduced hacking risk. Further, security is increased upon accessing the secondary site. Further, the present invention provides authentication information with various attributes and use methods and enables a combination of the convenience of online and the security of offline, application of a multi-login structure, economical security, easier notice of authentication information and resultant quick response, and easier changing of the person's ID.

The present invention may support payment using the function where the customized Internet portal is associated with the secondary site. Further, despite individual-dedicated sites, common services can be provided, thus creating various profits (e.g., use fees, advertisement fees, and sales profits).

### BRIEF DESCRIPTION OF THE DRAWINGS

FIG. 1 is a block diagram illustrating an embodiment of an Internet portal system according to the present invention;

FIG. 2 is a block diagram illustrating another embodiment of the Internet portal system according to the present invention;

FIG. 3 is a block diagram illustrating an embodiment of an Internet portal system supporting payment using FIG. 1;

FIG. 4 is a block diagram illustrating an embodiment of an Internet portal system supporting payment using FIG. 2;

FIG. 5 is a block diagram illustrating another embodiment of FIG. 3;

FIG. 6 is a block diagram illustrating another embodiment of FIG. 4;

FIG. 7 is a flowchart illustrating operations of the smart device of FIG. 1;

FIG. 8 is a flowchart illustrating operations of the private portal server of FIG. 1;

FIG. 9 is a flowchart illustrating operations of the secondary site server of FIG. 1;

FIG. 10 is a flowchart illustrating operations of the smart device of FIGS. 2, 4, and 6;

FIG. 11 is a flowchart illustrating operations of the private portal server of FIGS. 2, 4, and 6;

FIG. 12 is a flowchart illustrating operations of the secondary site server of FIGS. 2, 4, and 6 or FIGS. 4 and 6;

FIG. 13 is a flowchart illustrating operations of the smart device of FIGS. 3 and 5;

FIG. 14 is a flowchart illustrating operations of the private portal server of FIGS. 3 and 5;

FIG. 15 is a flowchart illustrating operations of the secondary site server of FIGS. 3 and 5;

FIG. 16 is a flowchart illustrating operations of the secondary site interworking server of FIGS. 3, 4, 5, and 6; and

FIG. 17 is a flowchart illustrating operations of the payment terminal of FIGS. 3, 4, 5, and

### DETAILED DESCRIPTION OF EXEMPLARY EMBODIMENTS

Hereinafter, preferred embodiments of the present invention are described in detail with reference to the accompanying drawings. The terms used herein should be interpreted not in typical or dictionary definitions but to comply in concept with the technical matters of the present invention.

The configurations disclosed in the specification and the drawings are mere examples and do not overall represent the technical spirit of the present invention. Therefore, various changes may be made thereto, and equivalents thereof also belong to the scope of the present invention.

Internet portal means a ‘gate’ that should be passed to enter the Internet. Internet portals are provided to be accessible by anyone. Uniform resource locator (URL) means the location of a file in servers providing various web document services. Page means a screen where information is shown on an Internet terminal. Near field communication (NFC) is used when a URL medium and a smart device communicate URLs.

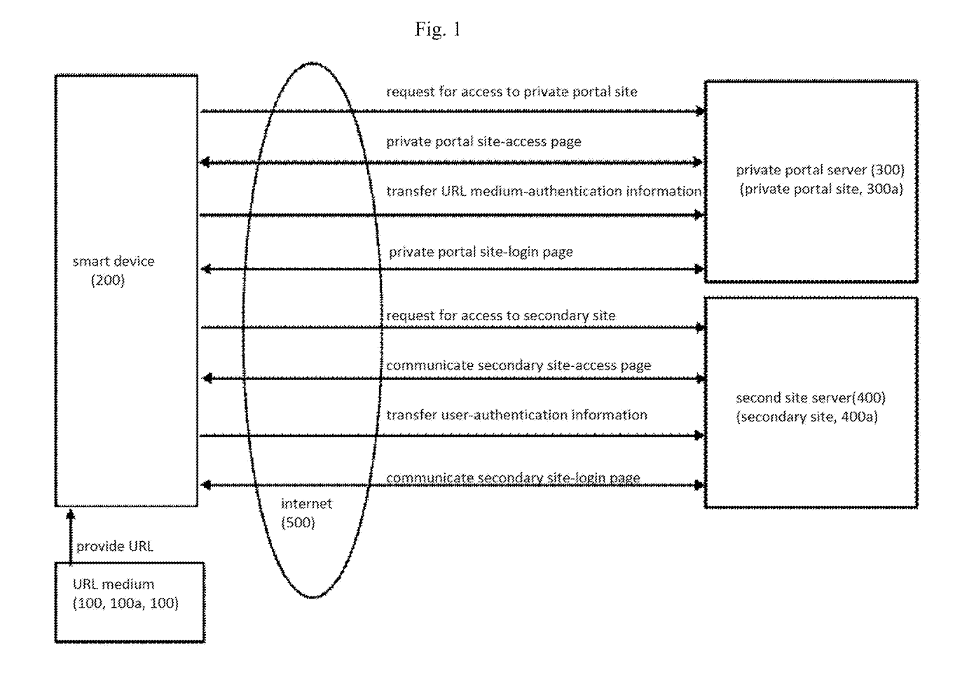

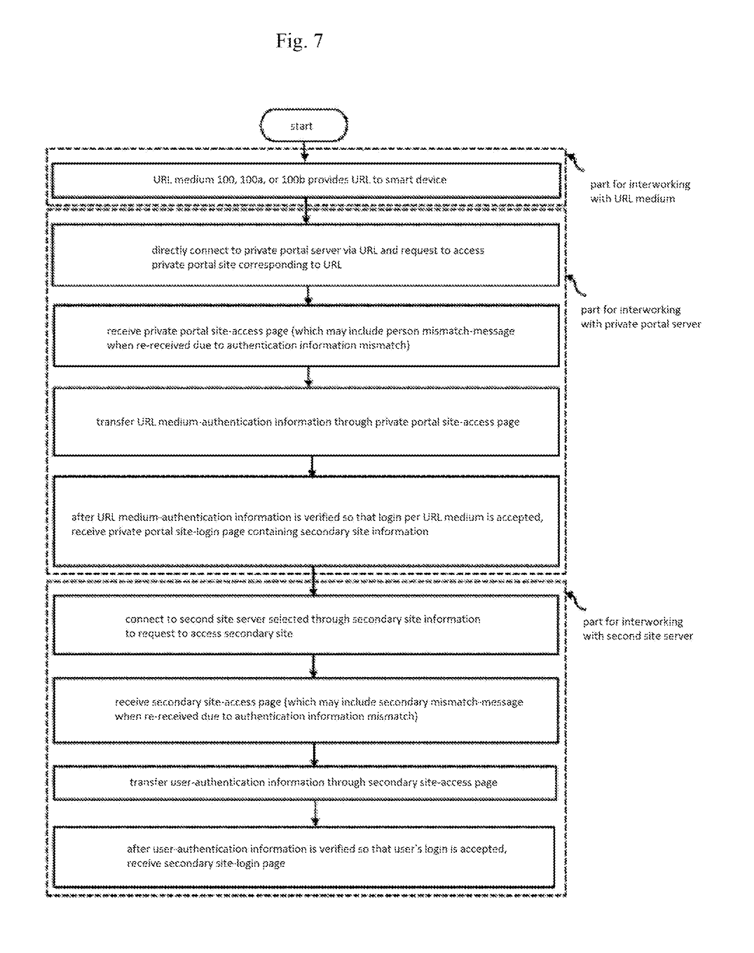

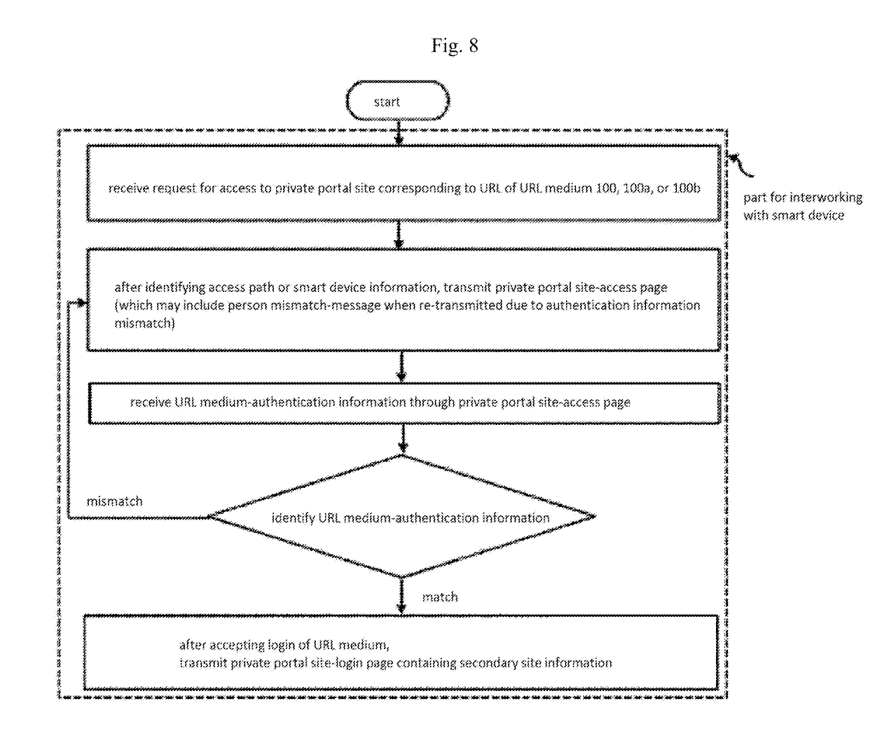

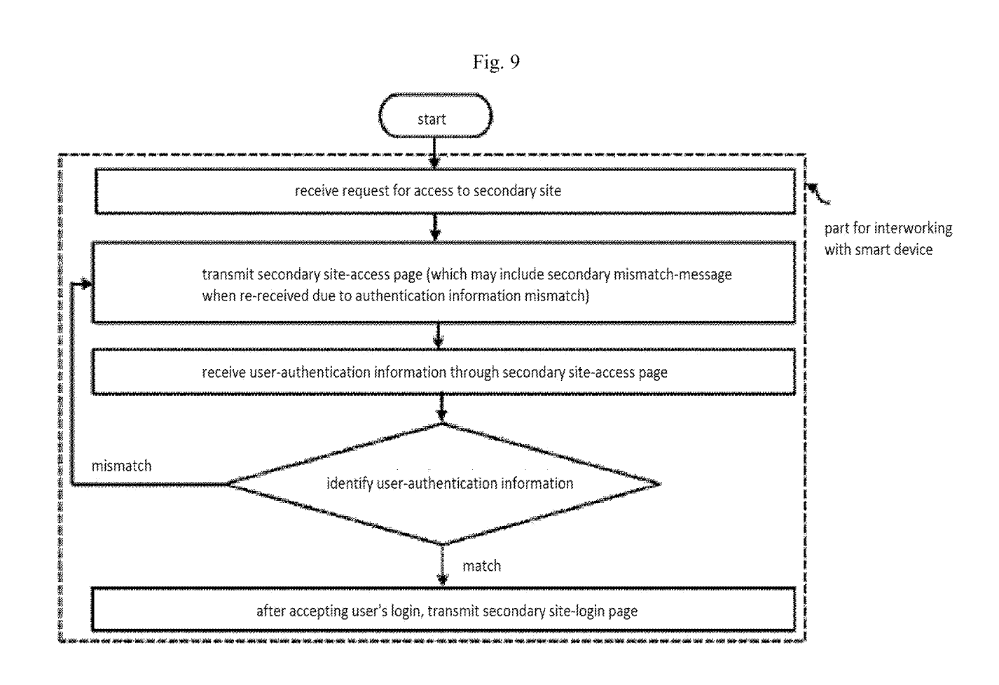

Referring to FIGS. 1, 7, 8, and 9, which are block diagrams and flowcharts of an embodiment of the present invention, a URL medium 100,100a, or 100b stores and provides a URL that includes individual distinguishing information and that allows for access to an individual-dedicated private portal site, and the URL medium 100, 100a, or 100b retains URL medium-authentication information memorized and used by the user to which the URL is assigned and set corresponding to the URL. A smart device 200 receives the URL from the URL medium 100, 100a, or 100b via NFC communication. The smart device 200 connects to the private portal server 300 via the Internet 500 and using the URL to access a private portal site 300a corresponding to the URL, communicates a private portal site-access page, and transfers the URL medium-authentication information entered by the user of the URL medium to the private portal server. The private portal server identifies the URL medium-authentication information, accepts login per URL medium, and then communicates a private portal site-login page with the smart device. The user may access a secondary site or use a search function or advertisements on the private portal site-login page.

Referring to FIGS. 1, 7, 8, and 9, the smart device communicating the private portal site-login page connects to a secondary site server 400 that the user selects on the private portal site-login page, communicates a secondary site 400a, and transfers user-authentication information entered by the user through a secondary site-access page to the secondary site server. The secondary site server identifies the user-authentication information, accepts the user's login, and then communicates a secondary site-login page. The user uses information or services through the secondary site.

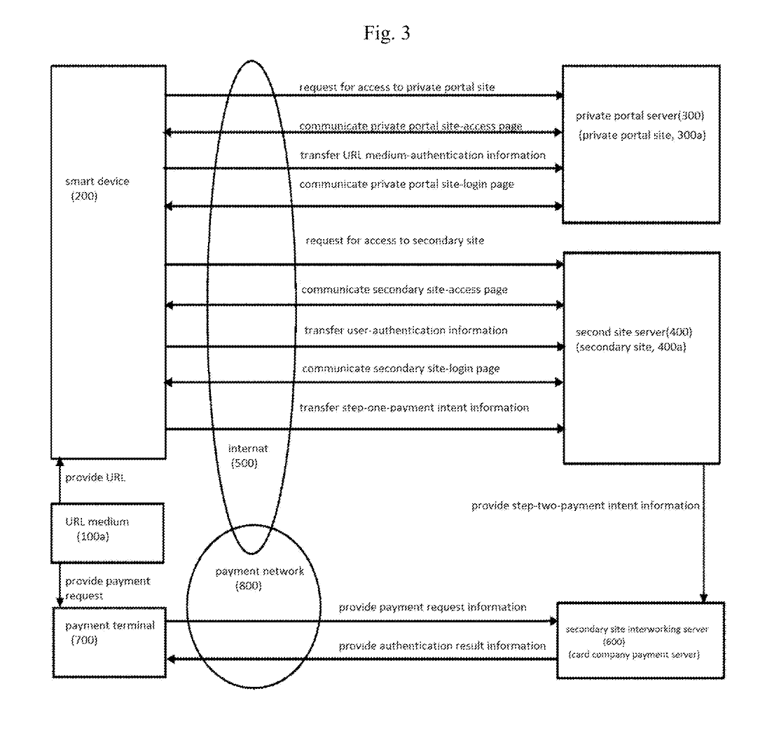

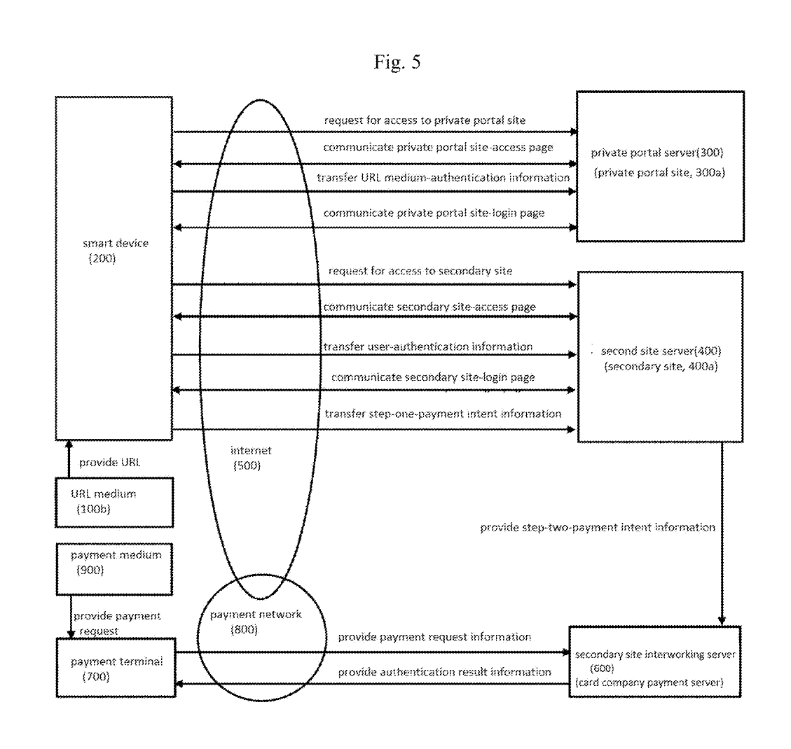

The Internet portal system capable of supporting payment via the system of FIGS. 3 and 5 and using the concept shown in FIGS. 1, 7, 8, and 9 has been invented.

A process for logging into a secondary site through a private portal site is structured with a first step in which a user's identity is automatically identified because only users with a URL medium are allowed to access a private portal server, a second step in which the user accessing with URL medium-authentication information is identified again, a third step in which the secondary site identifies the private portal site using information of the private portal site, and a fourth step in which the user is identified with user-authentication information of the secondary site. This structure enables safer and more convenient login by combining the URL medium, which exists off-line and information of the private portal site, which exists in the individual's memory and on-line. In the first step, information about the smart device may further be identified. The third step may be omitted.

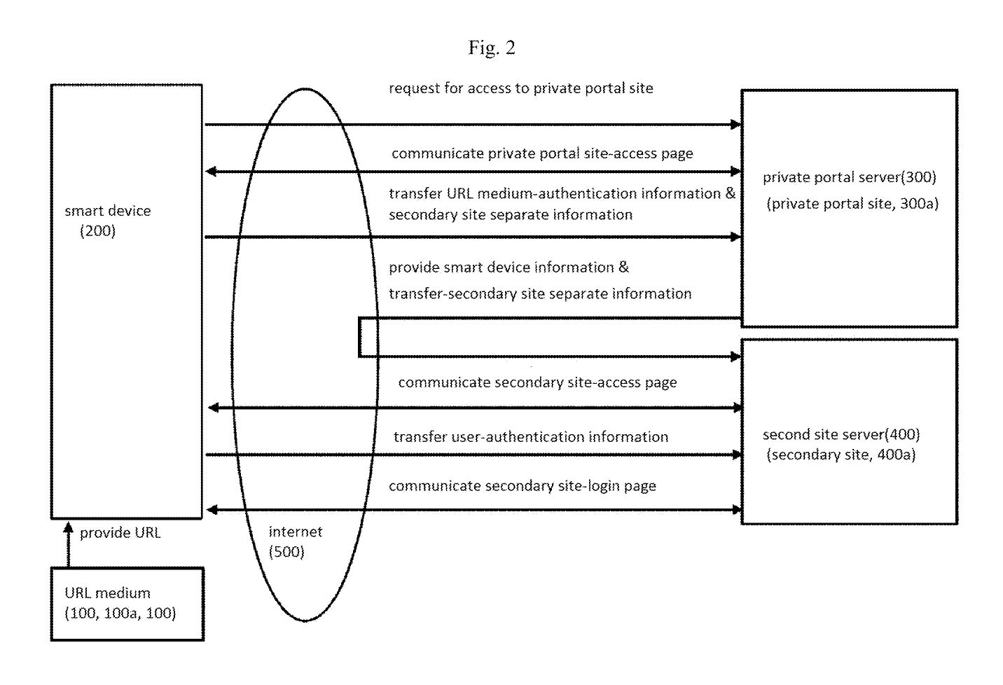

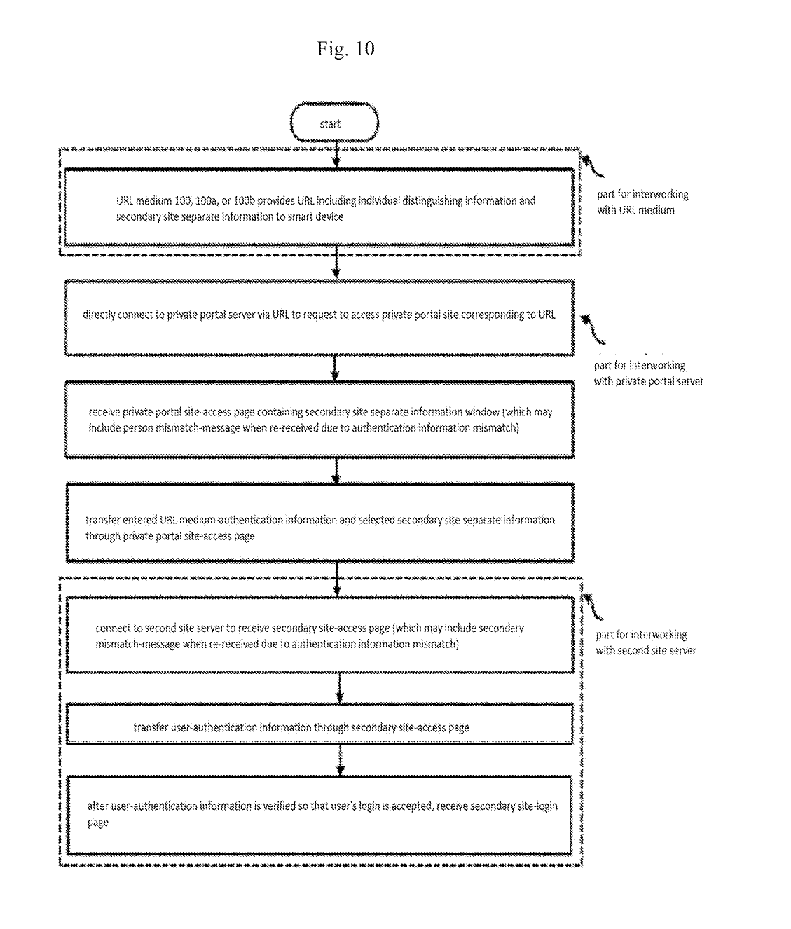

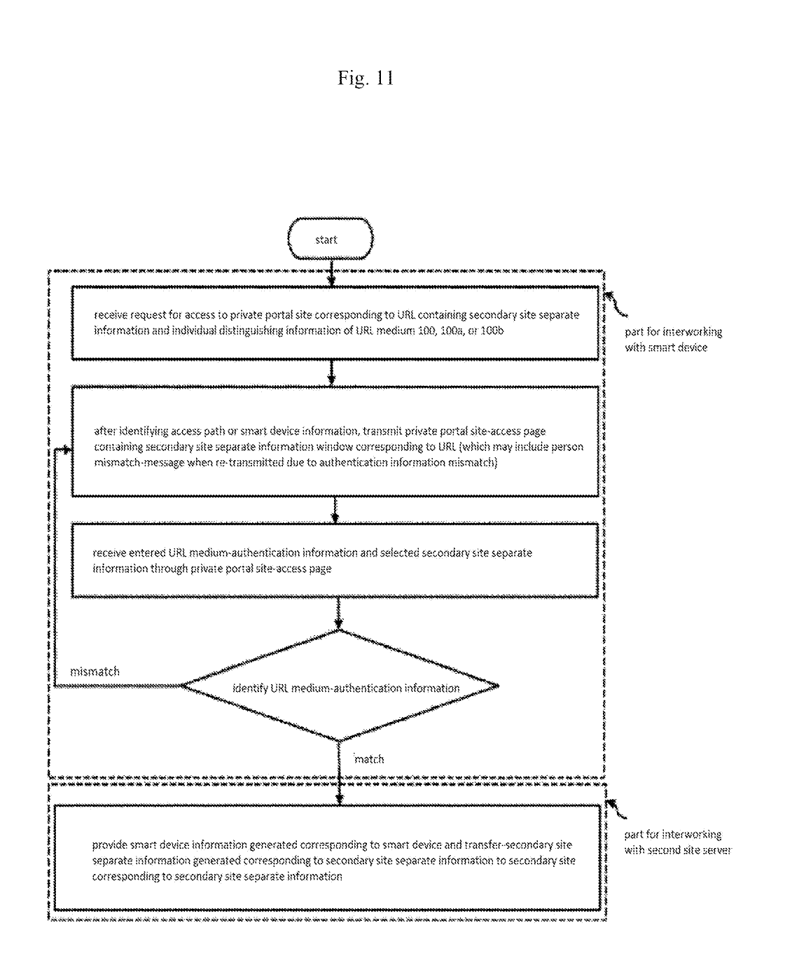

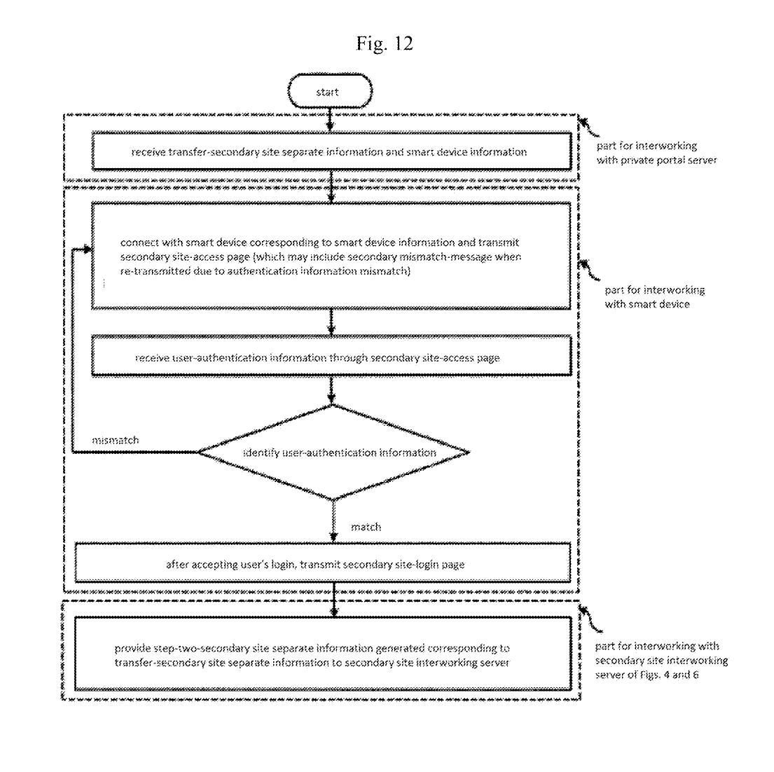

Referring to FIGS. 2, 10, 11, and 12, which are block diagrams and flowcharts of another embodiment of the present invention, a URL medium 100a or 100b stores and provides a URL that includes individual distinguishing information and secondary site separate information and that allows for access to an individual-dedicated private portal site, and the URL medium 100a or 100b retains URL medium-authentication information memorized and used by the user to which the URL is assigned and set corresponding to the URL. A smart device 200 receives the URL from the URL medium 100a or 100. The smart device 200 connects to the private portal server 300 via the Internet 500 and using the URL to access a private portal site 300a corresponding to the URL, communicates a private portal site-access page including a secondary site separate information window corresponding to the secondary site separate information, and transfers the URL medium-authentication information entered by the user and secondary site separate information selected by clicking the secondary site separate information window to the private portal server. The private portal site identifies the URL medium-authentication information, accepts the login of the URL medium, and then generates smart device information corresponding to the smart device and transfer-secondary site separate information corresponding to the secondary site separate information and provides the smart device information and the transfer-secondary site separate information to a secondary site server 400 corresponding to the secondary site separate information. The secondary site server connects with the smart device corresponding to the smart device information, communicates a secondary site-access page, identifies user-authentication information entered by the user and transferred, accepts the user's login, and then communicates a secondary site-login page with the smart device. The user uses information or services through the secondary site.

Referring to FIGS. 2, 10, 11, and 12, if the user transfers the URL medium-authentication information alone without selecting the secondary site separate information from the private portal site-access page, then, after the login of the URL medium 100a or 100b is accepted, the smart device and the private portal server communicate the private portal site-login page, and the user accesses the secondary site using the private portal site-login page or uses other services on the private portal site.

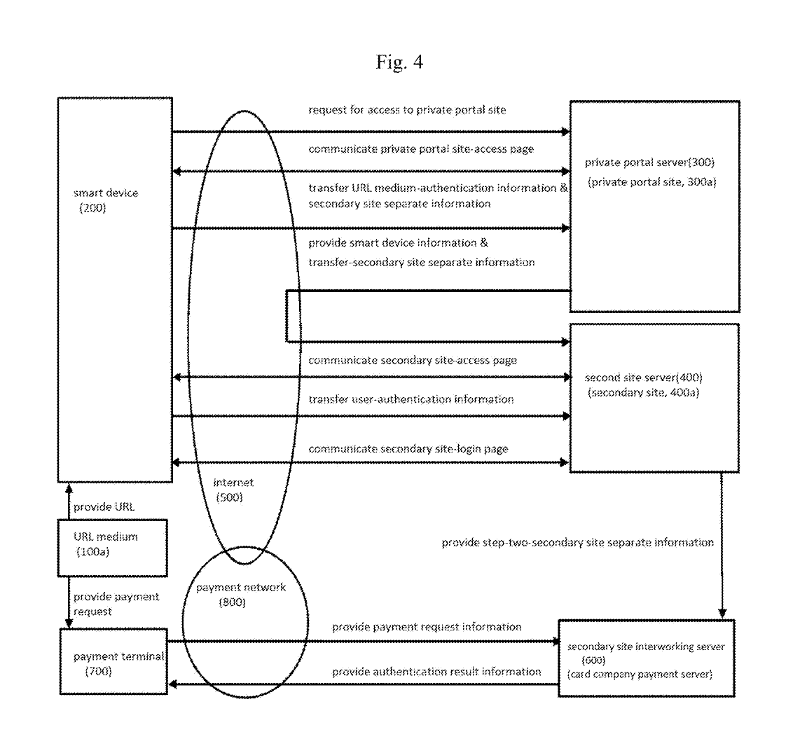

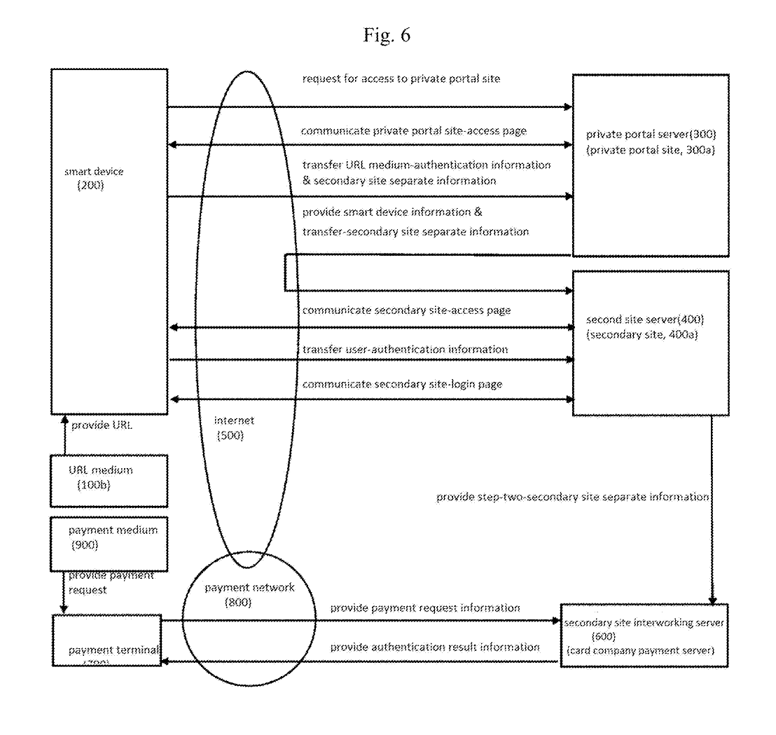

As per current methods for accessing a secondary site through a portal, a secondary site is searched for without identifying an individual who accesses the portal, and after accessing, a particular service is searched for and used. However, as per the method of FIGS. 2, 10, 11, and 12, the private portal site may conveniently be accessed using the URL containing the secondary site separate information which is information related to the secondary site, and the secondary site may be accessed to enable immediate use of a particular service while identifying the individual in multiple manners. The Internet portal system supporting payment with the system of FIGS. 4 and 6 has been invented.

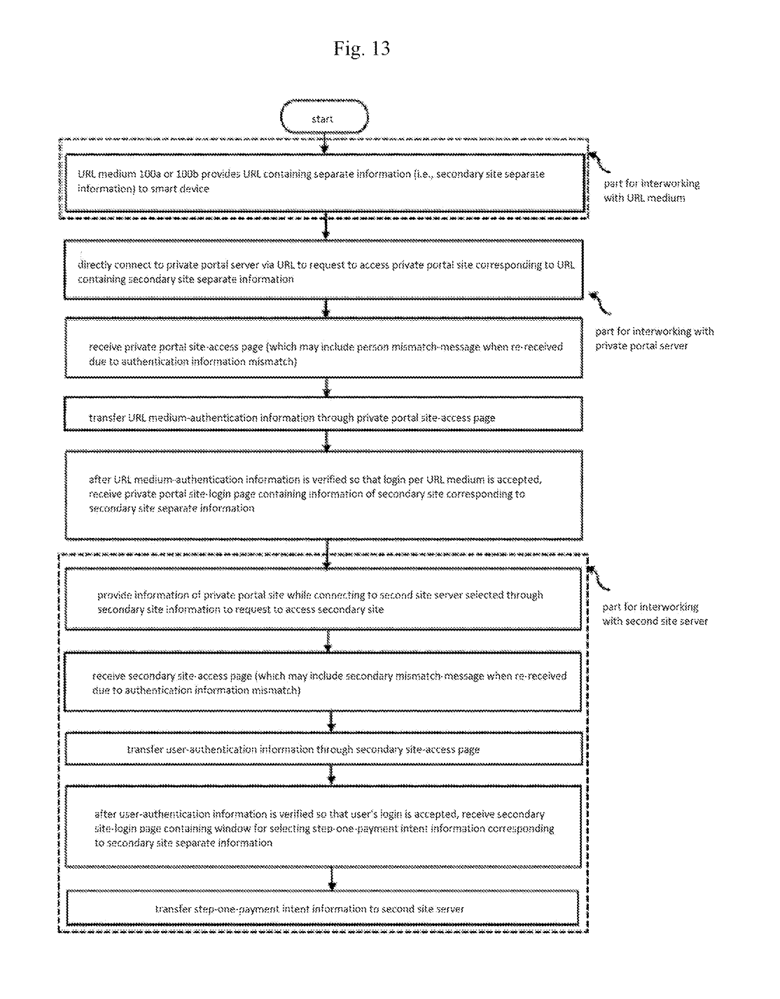

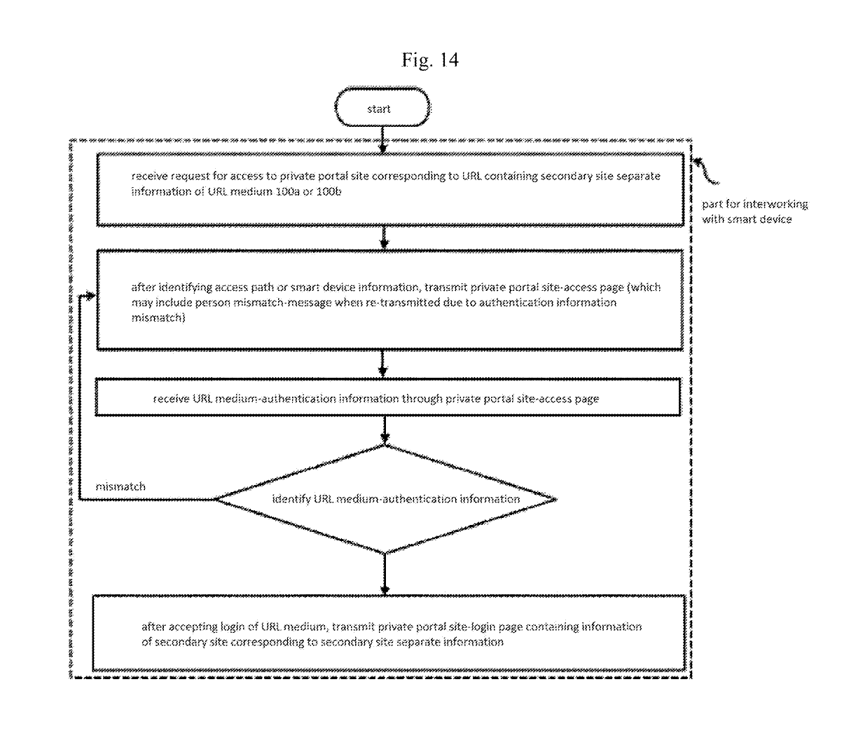

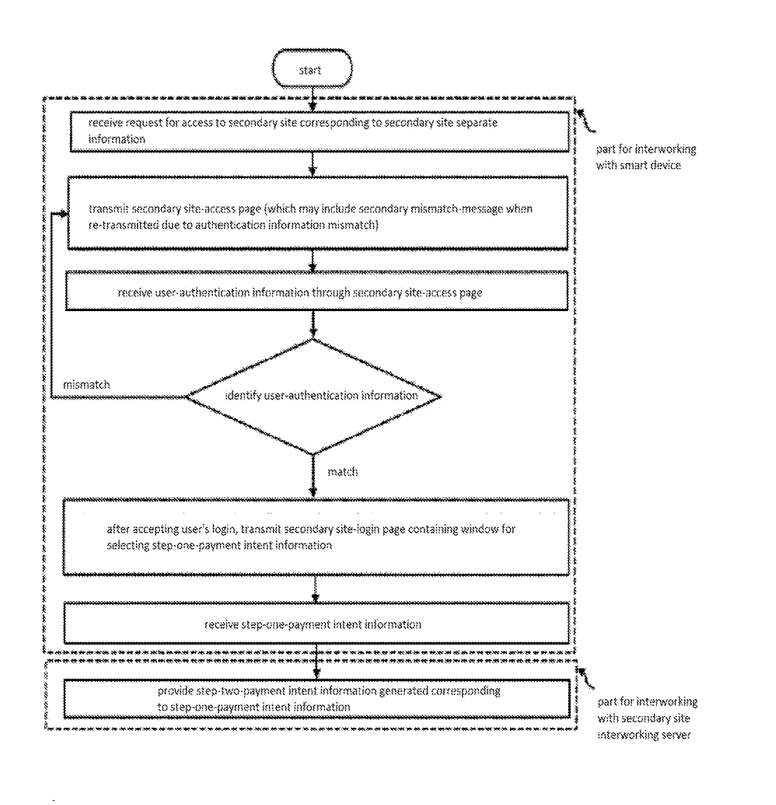

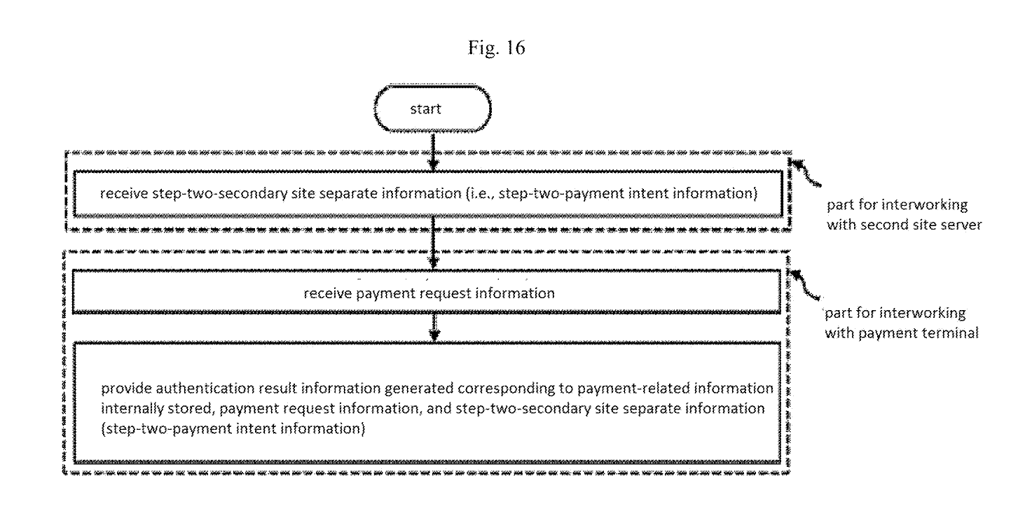

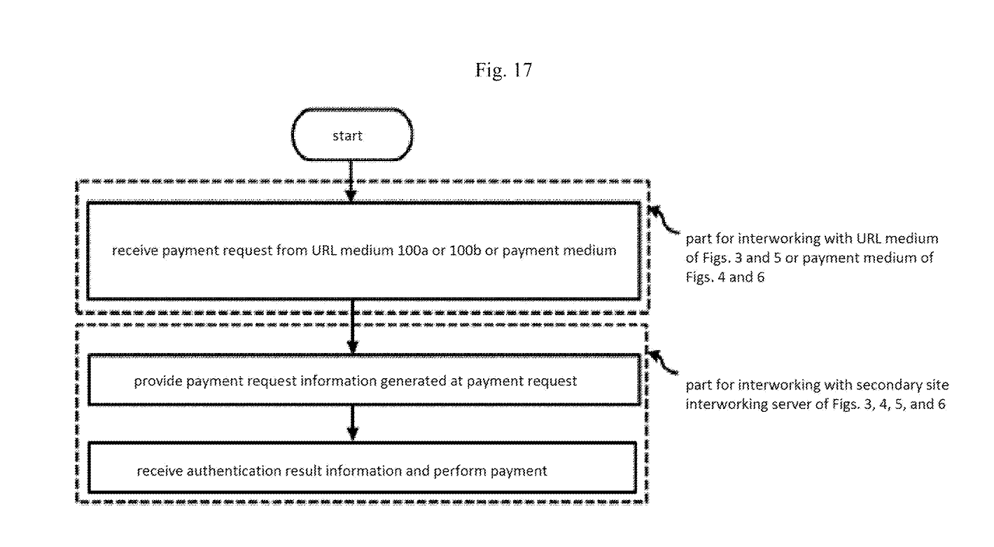

In FIGS. 3, 5, 13, 14, 15, 16, and 17, which are block diagrams and flowcharts illustrating an embodiment supporting payment according to the present invention, a URL medium 100a stores and provides a URL which includes individual distinguishing information and secondary site separate information associated with a payment function and allows for access to an individual-dedicated private portal site, and the URL medium 100a retains URL medium-authentication information, which is memorized and used by the user to which the URL is assigned and set corresponding to the URL, and a payment function in the same medium. A URL medium 100b stores and provides a URL which includes and individual distinguishing information and secondary site separate information associated with a payment function of a payment medium 900 and which allows for access to an individual-dedicated private portal site, and the URL medium 100b retains URL medium-authentication information that is memorized and used by the user to which the URL is assigned and that is set corresponding to the URL. A smart device 200 receives the URL from the URL medium 100a or the URL medium 100b, connects to a private portal server 300 via the Internet 500 and using the URL to access a private portal site 300a corresponding to the URL, communicates a private portal site-access page, and transfers the URL medium-authentication information entered by the user to the private portal server. The private portal server identifies the URL medium-authentication information and accepts login per URL medium, and then communicates a private portal site-login page containing a secondary site corresponding to the secondary site separate information with the smart device. The user connects with a secondary site server 400 through a private portal site-login page, communicates the secondary site 400a and transfers user-authentication information entered by the user on the secondary site-access page to the secondary site server. The secondary site server identifies the user-authentication information and accepts the user's login, and then communicates a secondary site-login page to receive step-one-payment intent information, and provides step-two-payment intent information generated corresponding to the received step-one-payment intent information to a secondary site interworking server (e.g., a card company payment server). The card company payment server receives and stores the step-two-payment intent information. The user provides a payment request to a payment terminal via the URL medium 100a or the payment medium. The payment terminal provides payment request information generated corresponding to the received payment request to the card company payment server. The card company payment server generates authentication result information corresponding to the payment request information and the step-two-payment intent information and payment-related information (e.g., valid period, payment limit, or credit status) of the URL medium 100a or the payment medium, which is previously known to the card company payment server, and the card company payment server provides the authentication result information to the payment terminal. The payment terminal performs payment corresponding to the authentication result information.

In the operations related to FIGS. 3, 5, 13, 14, 15, and 16, after the URL medium 100a or the payment medium 900 provides the payment request to the payment terminal, the URL medium 100a or 100b may provide the URL to the smart device to perform payment. The user of the URL medium 100a or 100b may use searches, advertisements, or other services without accessing the secondary site using the private portal site-login page. The user may use other services of the secondary site without transferring the step-one-payment intent information using the secondary site-login page or the user may use other services of the secondary site after transferring the step-one-payment intent information.

Referring to FIGS. 4, 6, 10, 11, 12, 16, and 17, which are block diagrams and flowcharts illustrating another embodiment supporting payment according to the present invention, a URL medium 100a stores and provides a URL which includes individual distinguishing information and secondary site separate information associated with a payment function and allows for access to an individual-dedicated private portal site, and the URL medium 100a retains URL medium-authentication information, which is memorized and used by the user to which the URL is assigned and set corresponding to the URL, and a payment function in the same medium. A URL medium 100b stores and provides a URL which includes and individual distinguishing information and secondary site separate information associated with a payment function of a payment medium 900 and which allows for access to an individual-dedicated private portal site, and the URL medium 100b retains URL medium-authentication information that is memorized and used by the user to which the URL is assigned and that is set corresponding to the URL. A smart device 200 receives the URL from the URL medium 100a or the URL medium 100b, connects to a private portal server 300 via the Internet 500 and using the URL to access a private portal site 300a corresponding to the URL, communicates a private portal site-access page containing a secondary site separate information window corresponding to the secondary site separate information, and transfers the URL medium-authentication information entered by the user and secondary site separate information selected by clicking the secondary site separate information window to the private portal server. The private portal server identifies the URL medium-authentication information and accepts the login of the URL medium, and then generates smart device information corresponding to the smart device and transfer-secondary site separate information corresponding to the secondary site separate information, and provides the smart device information and the transfer-secondary site separate information to the secondary site server 400 corresponding to the secondary site separate information. The secondary site server connects with the smart device corresponding to the smart device information, communicates a secondary site-access page, identifies user-authentication information entered by the user and transferred, and accepts the user's login, and then communicates the secondary site-login page with the smart device, and provides step-two-secondary site separate information generated corresponding to the transfer-secondary site separate information to a secondary site interworking server (i.e., a card company payment server). The card company payment server receives and stores the step-two-payment intent information. The user provides a payment request to the payment terminal via the URL medium 100a or the payment medium. The payment terminal provides payment request information generated corresponding to the received payment request to the card company payment server. The card company payment server generates authentication result information corresponding to the payment request information and the step-two-payment intent information and payment-related information of the URL medium 100a or the payment medium which is previously stored in the card company payment server, and the card company payment server provides the authentication result information to the payment terminal. The payment terminal performs payment corresponding to the authentication result information.

In the operations related to FIGS. 4, 6, 10, 11, 12, 16, and 17, after the URL medium 100a or the payment medium 900 provides the payment request to the payment terminal, the URL medium 100a or 100b may provide the URL to the smart device to perform payment. The user of the URL medium 100a or 100b may transfer the URL medium-authentication information alone through the private portal site-access page received by communicating the private portal site 300a corresponding to the URL containing the individual distinguishing information and separate information, and after the login of the URL medium 100a or 100b is accepted, communicate the private portal site-login page and enables use of other services (e.g., search function or advertisements) of the private portal site without accessing the secondary site or access to the secondary site that is irrelevant to the secondary site separate information of the URL.

The URL medium 100, 100a, or 100b is a medium that stores a URL, which is assigned per individual, in an NFC chip to enable direct access to an individual-dedicated private portal site without passing through other Internet path.

As per the properties of the URL, (1) the URL is assigned to an individual whose identity has been verified, and the URL includes individual distinguishing information that means the identity of the individual and allows for access to an individual-dedicated private portal site; (2) the URL is used through the URL medium in the access step; (3) the URL, although used like authentication information to identify the individual's identity, is not memorized by the user; (4) the URL is generated by the company operating the private portal server; (5) the URL is stored in the URL medium and used; (6) although the URL leaks out, it would not likely be used for fraudulent purposes because it needs to be used in the URL medium; (7) because the URL is managed in the URL medium, its loss or leakage can easily be realized; (8) when the URL leaks out, it can easily be varied; (9) the URL may contain other information, e.g., the separate information, along with the individual distinguishing information, which enable creation of various services; (10) since the URL is assigned per individual, a method for distinguishing between individuals with the URL associated with the individual's smart device is easily applicable; and (11) an individual may possess a plurality of URLs and use a plurality of private portal sites corresponding to the URLs.

Types of URL mediums include a URL medium 100 that stores a URL which includes individual distinguishing information, as a substitute for the individual's identity, and enables access to the private portal site, a URL medium 100a (refer to FIGS. 2, 3, and 4) that stores a URL which retains a separate function (e.g., payment function) in the same medium, includes individual distinguishing information and separate information (e.g., the secondary site separate information) about the separate function, and enables access to the private portal site, and a URL medium 100b (refer to FIGS. 2, 5 and 6) which stores a URL which includes individual distinguishing information and separate information associated with a separate medium (e.g., the payment medium) and enables access to the private portal site.

The individual distinguishing information is information constituting the URL, replaces the individual's identity, and is included regardless of the type of URL medium.

The separate function refers to a function that is associated with the URL but is not operated on the private portal server. The separate medium refers to a medium with the separate function. The separate information refers to information contained in the URL in relation with the separate medium, and in this disclosure, the secondary site separate information corresponds to the separate information. The secondary site separate information refers to information that enables access to the secondary site supporting the separate medium via the private portal site. The secondary site separate information window is a window included in the private portal site-access page to enable selection of use of the secondary site separate information.

The user of the URL medium is a person whose identity has been verified and to which the URL medium storing the assigned URL has been issued. Typically, the user of the URL medium is identical to the user of the secondary site.

The URL medium-authentication information is authentication information used upon logging into the private portal site. The URL medium-authentication information is set corresponding to the URL, memorized, and used by the user of the URL medium. The private portal server identifies the URL medium-authentication information and accepts login per URL medium (i.e., per URL).

In the method of accessing the private portal site, the private portal server rejects the access when passing through other Internet site but accepts the access when directly connected via the URL medium.

In the method of further using information about the smart device upon accessing the private portal site, information about the smart device currently in connection and information about the smart device that had connection before are compared, and if they are the same, the access is accepted, but if different, the access is rejected.

When the smart device is changed, the smart device is newly registered in the private portal server.

The per-URL medium login method allows access to the private portal site only when the private portal server uses the URL medium in the access step, as the first step, and identifies the URL medium-authentication information set per URL and accepts the login in the login step, as the second step. Such method uses the URL medium and the URL medium-authentication information and provides a base for fundamentally prevent fraudulent attacks.

In the method of using the URL containing the individual distinguishing information and the secondary site separate information, the private portal server receiving the URL containing the individual distinguishing information and the secondary site separate information, after identifying the individual, identifies the URL medium-authentication information received through the private portal site-access page, which does not contain the secondary site separate information window, and then communicates the private portal site-login page, which includes the secondary site corresponding to the secondary site separate information, with the smart device (refer to FIGS. 3 and 5); or it receives the secondary site separate information and the URL medium-authentication information through the private portal site-access page containing the secondary site separate information window and identifies the URL medium-authentication information, then generates the transfer-secondary site separate information corresponding to the secondary site separate information and provides the transfer-secondary site separate information to the secondary site corresponding to the secondary site separate information (refer to FIGS. 2, 4, and 6).

If only the URL medium-authentication information is entered through the private portal site-access page containing the secondary site separate information window and is transferred, then it identifies the URL medium-authentication information and then communicates the private portal site-login page with the smart device.

The smart device 200 is an electronic device that includes an NFC communication function, the function of exchanging information with the user through, e.g., the screen, and the function of enabling use of the Internet. The smart device 200 communicates with the private portal server or the secondary site server.

The smart device information is information about the smart device and may include, e.g., the IP, OS serial number, MAC address, or international mobile equipment identity (IMEI) of the smart device. The smart device information is provided when the smart device accesses the private portal server or when the private portal server connects the secondary site server to the smart device.

The private portal server 300 is a web server that manages the private portal sites 300a corresponding to the respective URLs of URL mediums.

The private portal server of FIG. 1 receives the URL containing the individual distinguishing information, identifies the URL medium-authentication information received by communicating the private portal site-access page, which includes a window for entry of the URL medium-authentication information, with the smart device, accepts login per URL medium, and then communicates the private portal site-login page, which includes a secondary site list, a search function, or advertisements.

The private portal server of FIGS. 3 and 5 receives the URL containing the individual distinguishing information and the secondary site separate information, communicates the private portal site-access page, which includes a window for entry of the URL medium-authentication information and the secondary site separate information window, with the smart device, receives the URL medium-authentication information and the secondary site separate information, identifies the URL medium-authentication information, accepts login per URL medium, and then communicates the private portal site-login page, which includes information of the secondary site corresponding to the secondary site separate information. If using other service on the private portal site without accessing the secondary site, the private portal server transfers the URL medium-authentication information alone.

The private portal server of FIGS. 2, 4, and 6 receives the URL containing the individual distinguishing information and the secondary site separate information, communicates the private portal site-access page, which includes a window for entry of the URL medium-authentication information and the secondary site separate information window, with the smart device, receives the URL medium-authentication information and the secondary site separate information, identifies the URL medium-authentication information, accepts login per URL medium, and then provides the smart device information generated corresponding to the smart device and the transfer-secondary site separate information generated corresponding to the secondary site separate information to the secondary site server corresponding to the secondary site separate information. If using other service on the private portal site without accessing the secondary site, the private portal server transfers the URL medium-authentication information alone.

The method of FIGS. 2, 4, and 6 enables use of services of the secondary site as simple as possible and is thus useful in the mobile era.

The above-described private portal site-secondary site-associated service may be provided to the user through prior-agreement between the operator of the private portal server and the operator of the secondary site. As an example of such application, the Internet portal system, which supports payment using a card company site, and method for using the same are shown in FIGS. 3, 4, 5, and 6.

The transfer-secondary site separate information is information that the private portal server generates corresponding to the received secondary site separate information and provides to the secondary site server.

The private portal server does not store private life information (e.g., card life information, insurance life information, bank account life information) other then minimum private information necessary to provide the private portal site, and the private portal server provides information that enables access to the private life site (e.g., card company site, insurance company site, or bank site) storing the person's life information.

The life information refers to information that is generated as the person does life activities and exists on the Internet, and the private life site refers to a site that provides the person's life information on the Internet, e.g., a card company site, insurance company, or bank site.

The private portal site 300a is a site that is managed by the private portal server, that is used only for the user of the URL medium, access to which is accepted by the private portal server identifying the access path of the URL or the smart device information, and to which login is performed per URL medium when the URL medium-authentication information set corresponding to the URL is identified. The private portal site 300a is divided into the private portal site-access page and the private portal site-login page. An individual may use the private portal site as many times as the number of URLs assigned thereto. The private portal site enables the site with the person's identity to exist on the Internet and may provide various services (e.g., use of life information) in interoperation with the secondary site.

The private portal site may include a search function for searching for the secondary site list or secondary site or advertisements.

The secondary site list is a list of secondary sites which are material to the user of the URL medium or the user of the URL medium is interested in and which the private portal site systematically provides. The secondary site list may be created by the operator of the private portal server or the individual, and the secondary site list may be available anywhere an Internet connection is made.

The private portal site-access page refers to a page where the private portal server communicates with the smart device until the private portal server accepts the access of the URL medium and identifies the URL medium-authentication information so that login is done per URL medium. The private portal site-access page includes the window for entry of the URL medium-authentication information, the secondary site separate information window, or content available even without login. The private portal site-access page includes a person mismatch-message when the URL medium-authentication information mismatches and is thus retransmitted.

The private portal site-login page is a page where the private portal server communicates with the smart device after identifying the URL medium-authentication information. The private portal site-login page includes content indicating that login to the page has been done, the secondary site list, or content that is available after login.

The private portal site-access page or the private portal site-login page may include a search function or advertisements.

The person mismatch-message is a message to notify that the authentication information mismatched when the private portal site-access page is retransmitted due to the URL medium-authentication information mismatch, and the private portal site-access page may be retransmitted with no content shown in the message.

The secondary site server 400 is a web server to manage the secondary site.

The secondary site server of FIG. 1 receives an access request from the smart device, identifies the user-authentication information received by communicating the secondary site-access page, accepts the user's login, and communicates the secondary site-login page.

The secondary site of FIGS. 3 and 5 receives the access request from the smart device, identifies the user-authentication information received by communicating the secondary site-access page, accepts the user's login, communicates the secondary site-login page, receives the step-one-payment intent information, and provides the step-two-payment intent information (the step-two-secondary site separate information) generated corresponding to the step-one-payment intent information to the secondary site interworking server (i.e., the card company payment server).

The secondary site server of FIG. 2 connects with the smart device corresponding to the smart device information received from the private portal server, identifies the user-authentication information received by communicating the secondary site-access page, then communicates the secondary site-login page, and corresponds to the received transfer-secondary site separate information.

The secondary site server of FIGS. 4 and 6 connects with the smart device corresponding to the smart device information received from the private portal server, identifies the user-authentication information received by communicating the secondary site-access page, then communicates the secondary site-login page, generates the step-two-secondary site separate information corresponding to the received transfer-secondary site separate information, and provides the step-two-secondary site separate information to the secondary site interworking server (i.e., the card company payment server).

The step-two-secondary site separate information is information that the secondary site server generates corresponding to the step-one-secondary site separate information and provides to the secondary site interworking server.

Secondary sites, which are all other sites than the private portal site, include private life sites (e.g., card company sites), login-required sites (e.g., shopping sites) from which critical information is available only when logged in, or normal sites (e.g., public relation (PR) sites) from which critical information is available without the need for login.

The secondary site-access page is a page that the secondary site server communicates with the smart device until before login is done for the user. Where the user-authentication information mismatches and is thus retransmitted, the secondary site-access page may include a secondary mismatch-message.

The secondary mismatch-message is a message to notify that the authentication information mismatched when the secondary site-access page is retransmitted due to the user-authentication information mismatch, and the secondary site-access page may be retransmitted with no content shown in the message.

The user-authentication information is authentication information that is set and used per user for the user to log into the secondary site.

The secondary site-login page is a page of the secondary site that is provided to the smart device after the user-authentication information is identified. The secondary site-login page may include a window through which the smart device may transfer the step-one-payment intent information to the secondary site server.

The step-one-payment intent information is information to notify the secondary site server that the user of the URL medium performs payment via a medium (URL medium 100a or payment medium) with the payment function.

The secondary site and the private portal site may support payment while interworking with each other, enable easier use of a person's information, automatically notify a private site that the person's life information has changed, or provide various particular services, e.g., providing individual-specific services.

The secondary site interworking server (i.e., the card company payment server 600) is a server that communicates with the secondary site server via an internal line, and referring to FIGS. 3, 4, 5, and 6, the secondary site interworking server is the card company payment server.

The card company payment server generates authentication result information corresponding to the payment request information received from the payment terminal, the step-two-secondary site separate information (i.e., the step-two-payment intent information) received from the secondary site server, and the payment-related information that the card company payment server previously and internally stores, and the card company payment server provides the authentication result information to the payment terminal.

The payment-related information is information (e.g., valid period or payment limit) related to the URL medium 100a or payment medium 900 with the payment function, and the payment-related information is internally and previously stored in the card company payment server.

The authentication result information is information about whether the card company payment server determined to authorize the payment, corresponding to the payment request from the URL medium 100a or the payment medium.

The payment terminal 700 may be, e.g., a POS terminal. The payment terminal 700 receives the payment request from the URL medium 100a or payment medium with the payment function to generate the payment request information, provides the payment request information through a payment network 800 to the secondary site interworking server, and performs payment corresponding to the authentication result information received from the secondary site interworking server.

The payment request information is information that the payment terminal generates corresponding to the payment request received from the URL medium 100a or the payment medium and provides to the secondary site interworking server.

The payment medium 900 means, e.g., a credit card, check card, or mobile card with payment functionality, and the payment medium 900 provides the payment request to the payment terminal.

The payment request means that the information contained in the URL medium 100a or the payment medium is provided to the payment terminal to request payment.

What is claimed is:

1. An Internet portal system, comprising:
a URL medium 100, 100a, or 100b storing and providing a URL including individual distinguishing information and enabling access to a private portal site and retaining URL medium-authentication information set in the URL memorized and used by a user to which the URL is assigned;
a smart device receiving the URL, accessing the private portal site corresponding to the URL, communicating a private portal site-access page, transferring the URL medium-authentication information entered by the user through the private portal site-access page, and after a login of the URL medium is accepted, communicating a private portal site-login page; and
a private portal server managing the private portal site, identifying the URL medium-authentication information received through the private portal site-access page, accepting the login of the URL medium, and then communicating the private portal site-login page with the smart device.

2. A method for using an Internet portal, the method comprising:
step a) in which a URL medium 100, 100a, or 100b provides a URL to a smart device;
step b) in which the smart device accesses a private portal site corresponding to the URL and transfers URL medium-authentication information entered by a user of the URL medium through a private portal site-access page to a private portal server; and
step c) in which the private portal server identifies the URL medium-authentication information, accepts a login of the URL medium, and then communicates a private portal site-login page with the smart device.

3. The Internet portal system of claim 1, wherein the smart device accesses a secondary site selected in the private portal site-login page, communicates a secondary site-access page, transfers user-authentication information entered by the user through the secondary site-access page, and after the user logs into the secondary site, communicates a secondary site-login page, and wherein the Internet portal system further comprises a secondary site server managing the secondary site, identifying the user-authentication information received through the secondary site-access page, and after accepting the user's login, communicating the secondary site-login page with the smart device.

4. The method of claim 2, further comprising:
step d) in which the smart device accesses a secondary site selected in the private portal site-login page and transfers user-authentication information entered by the user through a secondary site-access page to a secondary site server; and
step e) in which the secondary site server identifies the user-authentication information, accepts the user's login, and then communicates a secondary site-login page with the smart device.

5. An Internet portal system, comprising:
a URL medium 100a or 100b storing and providing a URL including individual distinguishing information and secondary site separate information and enabling access to a private portal site and retaining URL medium-authentication information set in the URL memorized and used by a user to which the URL is assigned;
a smart device receiving the URL, accessing the private portal site corresponding to the URL, communicating a private portal site-access page, transferring the URL medium-authentication information and the secondary site separate information entered by the user through the private portal site-access page, accessing a secondary site server corresponding to the secondary site separate information, transfers the user-authentication information entered by the user through a secondary site-access page, and after the user's login is accepted, communicating a secondary site-login page;
a private portal server managing the private portal site, communicating the private portal site-access page with the smart device, identifying the received URL medium-authentication information, accepting a login of the URL medium, and then providing transfer-secondary site separate information generated corresponding to the secondary site separate information and smart device information generated corresponding to the smart device to the secondary site server; and
a secondary site server managing the secondary site, receiving the secondary site separate information, accessing the smart device corresponding to the smart device information and the secondary site separate information, identifying the user-authentication information received through the secondary site-access page, accepting the user's login, and then communicating the secondary site-login page with the smart device.

6. A method for using an Internet portal, the method comprising:
step a) in which a URL medium 100a or 100b provides a URL to a smart device;
step b) in which the smart device accesses a private portal site corresponding to the URL, and transfers secondary site separate information and URL medium-authentication information entered by a user of the URL medium through a private portal site-access page to a private portal server;
step c) in which the private portal server identifies the URL medium-authentication information, accepts a login of the URL medium, and then provides transfer-secondary site separate information generated corresponding to the secondary site separate information and smart device information generated corresponding to the smart device to a secondary site server corresponding to the secondary site separate information;
step d) in which the secondary site server accesses the smart device corresponding to the transfer-secondary site separate information and the smart device information, and communicates a secondary site-access page;
step e) in which the smart device transfers user-authentication information entered by the user through the secondary site-access page to the secondary site server; and
step f) in which the secondary site server identifies the user-authentication information, accepts the user's login, and then communicates a secondary site-login page with the smart device.

7. An Internet portal system, comprising:
a URL medium 100a storing and providing a URL including individual distinguishing information and secondary site separate information corresponding to a payment function and enabling access to a private portal site and retaining the payment function and URL medium-authentication information set in the URL memorized and used by a user to which the URL is assigned;
a smart device receiving the URL, accessing the private portal site corresponding to the URL, communicating a private portal site-access page, transferring the URL medium-authentication information entered by the user through the private portal site-access page, and after the URL medium logs in, communicating a private portal site-login page, connecting to a secondary site server corresponding to the secondary site separate information through the private portal site-login page, communicating a secondary site-access page, transferring user-authentication information entered by the user through the secondary site-access page, and after the user logs in, transferring step-one-payment intent information through a secondary site-login page;
a private portal site managing the private portal site, identifying the URL medium-authentication information received through the private portal site-access page with the smart device, and after accepting the login of the URL medium, communicating the private portal site-login page with the smart device;
a secondary site server managing the secondary site, identifying the user-authentication information received through the secondary site-access page and the smart device, after accepting the user's login, receiving the step-one-payment intent information through the secondary site-login page, and providing step-two-payment intent information generated corresponding to the step-one-payment intent information to a secondary site interworking server;
a payment terminal providing payment request information generated at a payment request from the URL medium 100a to the secondary site interworking server and performing payment corresponding to authorization result information; and
the secondary site interworking server previously storing payment-related information of the URL medium 100a and providing the authorization result information generated corresponding to the payment request information and the step-two-payment intent information, and the payment-related information internally and previously stored to the payment terminal.

8. A method for using an Internet portal, the method comprising:
step a) in which a URL medium 100a provides a URL to a smart device;
step b) in which the smart device accesses a private portal site corresponding to the URL and transfers URL medium-authentication information entered by a user of the URL medium through a private portal site-access page to a private portal server;
step c) in which the private portal server identifies the URL medium-authentication information and after accepting a login of the URL medium, communicates a private portal site-login page with the smart device;
step d) in which the smart device accesses a secondary site selected by the user in the private portal site-login page, and transfers user-authentication information entered by the user through a secondary site-access page to a secondary site server;
step e) in which the secondary site server identifies the user-authentication information, and after accepting the user's login, communicates a secondary site-login page with the smart device;
step f) in which the smart device transfers step-one-payment intent information to the secondary site server through the secondary site-login page;
step g) in which the secondary site server generates step-two-payment intent information corresponding to the step-one-payment intent information, and provides the step-two-payment intent information to a secondary site interworking server;
step h) in which the URL medium 100a provides a payment request to a payment terminal;
step i) in which the payment terminal generates payment request information corresponding to the payment request and provides the payment request information to the secondary site interworking server;
step j) in which the secondary site interworking server generates authentication result information corresponding to the payment request information and the step-two-payment intent information and payment-related information of the URL medium 100a previously and internally stored and provides the authentication result information to the payment terminal; and
step k) in which the payment terminal performs payment corresponding to the authentication result information.

9. The Internet portal system of claim 5, wherein the URL medium 100a further retains a payment function to provide a payment request to a payment terminal, wherein the secondary site server provides step-two-secondary site separate information generated corresponding to the transfer-secondary site separate information to a secondary site interworking server, and wherein the Internet portal system further comprises a payment terminal providing payment request information generated at the payment request from the URL medium 100a to the secondary site interworking server and performing payment corresponding to authentication result information received from the secondary site interworking server; and the secondary site interworking server previously storing payment related information of the URL medium 100a, generating the authentication result information corresponding to the payment request information and the step-two-payment intent information and the payment-related information internally and previously stored, and providing the authentication result information to the payment terminal.

10. The method of claim 6, further comprising:
step g) in which the secondary site server provides step-two-secondary site separate information generated corresponding to the transfer-secondary site separate information to a secondary site interworking server;
step h) in which the secondary site interworking server receives and stores the step-two-secondary site separate information;
step i) in which the URL medium 100a provides a payment request to a payment terminal;
step j) in which the payment terminal provides payment request information generated at the payment request to the secondary site interworking server;
step k) in which the secondary site interworking server generates authentication result information corresponding to the payment request information and the step-two-payment intent information, and payment-related information of the URL medium 100a internally and previously stored, and provides the authentication result information to the payment terminal; and
step l) in which the payment terminal performs payment corresponding to the authentication result information.

11. The Internet portal system of claim 5, wherein the secondary site server further provides step-two-secondary site separate information generated corresponding to the transfer-secondary site separate information to a secondary site interworking server, and wherein the Internet portal system further comprises:
a payment medium associated with the URL medium 100b through the secondary site separate information, retaining a payment function, and providing a payment request to a payment terminal;
a payment terminal providing payment request information generated at the payment request to the secondary site interworking server and performing payment corresponding to authentication result information received from the secondary site interworking server; and
the secondary site interworking server previously storing payment related information of the payment medium 900, generating the authentication result information corresponding to the payment request information and the step-two-payment intent information and the payment-related information internally and previously stored, and providing the authentication result information to the payment terminal.

12. The method of claim 6, further comprising:
step g) in which the secondary site server provides step-two-secondary site separate information generated corresponding to the transfer-secondary site separate information to a secondary site interworking server;
step h) in which the secondary site interworking server receives and stores the step-two-secondary site separate information;
step i) in which the payment medium provides a payment request to a payment terminal;
step j) in which the payment terminal provides payment request information generated at the payment request to the secondary site interworking server;
step k) in which the secondary site interworking server generates authentication result information corresponding to the payment request information and the step-two-payment intent information, and payment-related information of the payment medium internally and previously stored, and provides the authentication result information to the payment terminal; and
step l) in which the payment terminal performs payment corresponding to the authentication result information.
